(19) United States
(12) Patent Application Publication
(10) Pub. No.: US 2009/0216897 A1
(43) Pub. Date: Aug. 27, 2009

(54) METHOD AND SYSTEM FOR CONTROLLING STREAMING RATES

(75) Inventor: Zhimin Wang, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/437,290

(22) Filed: May 7, 2009

Related U.S. Application Data
(63) Continuation of application No. PCT/CN2008/070186, filed on Jan. 25, 2008.

(30) Foreign Application Priority Data
Apr. 13, 2007 (CN) 200710090127.7

(51) Int. Cl. G06F 15/16

(52) U.S. Cl. 709/231

(57) ABSTRACT

A streaming rate control method disclosed herein includes: judging whether it is necessary to adjust the rate of the media stream sent to the UE according to the network state fed back by the UE; if necessary, obtaining the adaptation parameters; adapting the rate of the media stream according to the adaptation parameters; and sending the adapted media stream to the UE. A system and a device for controlling streaming rates are disclosed herein. The rate adaptation server adapts the streaming rate required by the streaming server; on the streaming server, the source needs only to be stored at a single rate, which saves the storage space on the streaming server and simplifies encoding of the streaming source.

### CROSS-REFERENCE TO RELATED APPLICATIONS

This application is a continuation of International Application No. PCT/CN2008/070186, filed on Jan. 25, 2008, which claims the benefit of Chinese Patent Application No. 200710090127.7, filed on Apr. 13, 2007, both of which are hereby incorporated by reference in their entireties.

### FIELD OF THE DISCLOSURE

The present disclosure relates to the field of communication technologies, and in particular, to a method and system for controlling streaming rates.

### BACKGROUND

With the development of communication technologies, especially radio mobile network technologies, the network bandwidth is sufficient for implementing real-time streaming services, and the streaming service has become an orientation of the value-added services in the future communication industry. In order to make the most of the existing network resources and improve the user experience, a Quality of Service (QoS) control mechanism needs to be introduced while a streaming service is implemented. Especially for the radio networks with sharply different bandwidth, the QoS control mechanism enhances the user service experience massively and makes the service more appealing to users.

In the conventional technology, the streaming QoS control is performed through Multiple Bit Rate (MBR). The principles are: When the encoder encodes the content, the encoder selects different rates such as 30 Kbps, 60 Kbps, and 100 Kbps, the same program source is encoded into a streaming file at those different rates, and the streaming server stores the streaming file that includes multiple bit rates as a program source. In the process of playing the streaming media, the streaming server interacts with the player of User Equipment (UE) through a QoS control protocol. According to the feedback of the UE, the streaming server obtains the current network state, selects the stream of the proper rate and sends it to the player of the UE for playing. For example, when the network state is favorable, the stream is played to the user at a 100 Kbps rate; when the network state is unfavorable, the stream is played to the user at a lower rate such as 60 Kbps or 30 Kbps.

In the process of researching the present invention, the inventor finds at least the following weaknesses in the conventional technology:

The above solution reveals that when the streaming QoS control is performed through MBR, it is necessary to encode the same program into the same streaming file at different rates, which increases the occupation of storage space on the streaming server. Moreover, in the process of creating an MBR file, few rates are available for encoding, and few rate parameters are available for selecting at the time of playing the media file, which hardly meets the requirement of bandwidth adaptation. Finally, in order to play an MBR file, enormous hardware and software resources of the streaming server need to be occupied, which increases the operation cost of the service. Especially when multiple servers are networked into a cluster, each streaming server must provide high performance, which increases the operation cost.

### SUMMARY

The present disclosure provides a method and system for controlling streaming rates to simplify encoding of the streaming source and save the streaming storage space.

The present disclosure provides a method for controlling streaming rates, including:

judging whether the rate of the media stream sent to the UE is appropriate according to the network state fed back by the UE;

obtaining the adaptation parameters when the rate is inappropriate;

adapting the rate of the media stream according to the adaptation parameters; and

sending the adapted media stream to the UE.

A system for controlling streaming rates in an embodiment of the present disclosure includes:

a streaming server, adapted to send the original media stream and adaptation parameters to the rate adaptation server, and send to the UE the adapted media stream sent by the rate adaptation server, when determining it necessary to adjust the rate of the media stream sent to the UE according to the network state fed back by the UE; and

a rate adaptation server, adapted to adapt the rate of the original media stream sent by the streaming server, and send the stream to the streaming server, according to the adaptation parameters sent by the streaming server.

A streaming server provided in an embodiment of the present disclosure includes:

a judging module, adapted to judge whether it is necessary to adapt the rate of the media stream sent to the UE according to the network state fed back by the UE, and send the judgment result of requiring rate adaptation to the streaming forwarding module;

a streaming forwarding module, adapted to send the original media stream to be adapted and the adaptation parameters to the rate adaptation server in the network; and

a streaming receiving module, adapted to receive the adapted media stream sent by the rate adaptation server in the network.

A rate adaptation server provided in an embodiment of the present disclosure includes:

a receiving module, adapted to store the original media stream sent by the streaming server into the buffer, and provide the stream for the rate converting module;

a rate converting module, adapted to perform rate adaptation for the media stream received by the receiving module according to the adaptation parameters sent by the streaming server; and

a sending module, adapted to send the media stream adapted by the rate converting module to the streaming server.

Compared with the prior art, the embodiments of the present invention provide the following benefits:

The rate adaptation server adapts the streaming rate required by the streaming server. On the streaming server, the source may be stored at a single rate, which saves the storage space on the streaming server and simplifies encoding of the streaming source.

### BRIEF DESCRIPTION OF THE DRAWINGS

FIG. 1 is a flowchart of a streaming rate control method according to one embodiment of the present disclosure;

FIG. 2 is a signaling flowchart of controlling streaming rates for different UEs according to one embodiment of the present disclosure;

FIG. 3 shows a structure of a streaming rate control system according to one embodiment of the present disclosure;

FIG. 4 shows a structure of a streaming server according to one embodiment of the present disclosure;

FIG. 5 shows a structure of a rate adaptation server according to one embodiment of the present disclosure; and

FIG. 6 shows a structure of a rate adaptation server cluster network according to one embodiment of the present disclosure.

### DETAILED DESCRIPTION

The present disclosure is hereinafter described in detail by reference to embodiments and accompanying drawings.

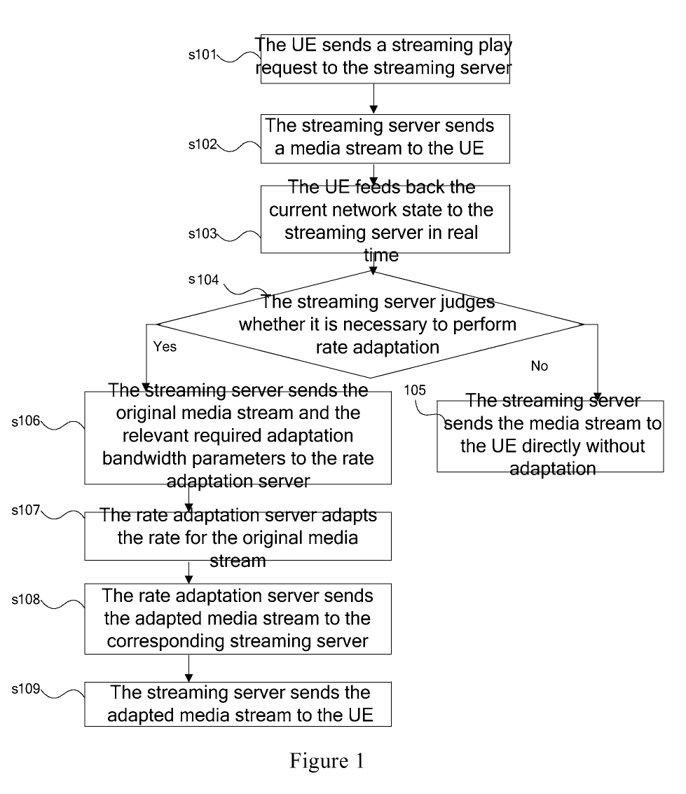

As shown in FIG. 1, a streaming rate control method in one embodiment of the present disclosure includes:

Block S101: A UE sends a streaming play request to a streaming server.

In this process, the UE sends the streaming play request to the streaming server through the Real Time Streaming Protocol (RTSP).

Block S102: The streaming server sends a media stream to the UE.

In this process, after the UE passes the authentication of the streaming server, the streaming server sends a media stream to the UE, and the UE plays the media stream. When selecting the initial rate of sending the media stream, the streaming server may refer to the network bandwidth and the transmission rate in the normal circumstances. After the foregoing factors are considered, the streaming server may use the rate in the normal state of the network as an initiate sending rate so that each UE may achieve the best effect of playing the media stream in normal circumstances. The streaming server identifies the media stream sent to different UEs through a session connection ID.

Block S103: The UE feeds back the current network state to the streaming server in real time.

In the process of playing the stream, the UE feeds back the current network state to the streaming server in real time through the Real Time Control Protocol (RTCP). The feedback RTCP packet may include these parameters: maximum sequence number of the packets received by the UE, quantity of lost packets, delay jitters, and timestamp.

Block S104: The streaming server judges whether it is necessary to perform rate adaptation: if not necessary, the process proceeds to block S105; if necessary, the process proceeds to block S106.

In this process, the streaming server estimates the delay according to the parameters resolved out of the RTCP packet, and determines whether it is necessary to adapt the rate according to the network conditions such as quantity of lost packets and delay jitters. In practice, each UE is located in a different environment, and the factors such as mobility, signal quality of the transmission channel, and bandwidth are ever changing. Therefore, pause and mosaic may occur when the UE plays media streams of high rates, which reduces the use experience of the UE. Meanwhile, the streaming server may estimate how to adjust the rate of sending the media stream according to the parameters, namely, estimate the rate that matches the network state of the UE. Therefore, the UE can achieve a better effect of playing the streaming file.

Block S105: The streaming server sends the original media stream to the UE directly without adaptation.

In this process, the rate of the media stream does not need to be adapted if the streaming server finds that the network state of the UE can play the media stream file normally.

Block S106: The streaming server sends the original media stream and the relevant required adaptation bandwidth parameters to the rate adaptation server.

In this process, the rate of the media stream may be adapted if the streaming server finds that the network state of the UE cannot play the media stream file normally. The streaming server sends the original media stream and the relevant required adaptation bandwidth parameters to the rate adaptation server according to the preset IP address of the rate adaptation server. The adaptation bandwidth parameters may include: connection ID of the session that involves the original media stream, and converted matching rate. The sent original media stream is borne over the Real-time Transport Protocol (RTP).

Block S107: The rate adaptation server adapts the rate for the original media stream.

In this process, the rate adaptation server adapts the rate for the original media stream sent by the streaming server according to the adaptation bandwidth parameters. Specifically, when receiving the original media stream forwarded by the streaming server, the rate adaptation server stores the original media stream into the buffer. Once a complete multimedia frame is received, the rate adaptation server adapts the rate for the multimedia frame and obtains the media stream of a matching rate received in block S106.

Block S108: The rate adaptation server sends the adapted media stream to the corresponding streaming server.

In this process, once the rate of a multimedia frame is adapted, the rate adaptation server sends the media stream that carries the adapted multimedia frame to the corresponding streaming server according to the address of the streaming server that sends the original media stream. The connection ID of the session that involves the adapted media stream may be carried. This ID is the same as the connection ID of the session that involves the media stream before adaptation, namely, the connection ID of the session that involves the original media stream received by the rate adaptation server in block S106.

Block S109: The streaming server sends the adapted media stream to the UE.

In this process, the streaming server sends the adapted media stream to the corresponding UE according to the connection ID of the session that involves the adapted media stream.

Through the method for controlling streaming rates in specific scenarios described the embodiment above, the streaming server judges whether it is necessary to adjust the rate of the streaming media sent to the UE in real time according to the network state fed back by the UE: If necessary, the rate adaptation server adapts the original media stream, and then the streaming server sends the adapted media stream to the UE. Therefore, the streaming source of one rate needs to be stored on the streaming server, thus saving the storage space on the streaming server and simplifying the encoding of the streaming source.

In one embodiment of the present disclosure, the streaming rate control method for different UEs in a 3G radio network is described. This embodiment supposes that the normal rate of playing the streaming media between the streaming server and the UE in the 3G radio network is 100 Kbps. In this case, the streaming source stored on the streaming server is encoded at 100 Kbps rate. It is supposed that the streaming server whose IP address is 192.168.1.2 provides a streaming service for UE 1 and UE 2 concurrently, and the rate adaptation requirements of the streaming server are handled by the rate adaptation server whose IP address is 192.168.1.10. The optional rates of playing the media stream between the streaming server and the UE may be any rate that varies continuously. However, in a complicated and fast changing environment of the radio network, slight change of network conditions leads to change of the rate. In order to avoid frequent conversion of rates, the optional rates adapted by the rate adaptation server may be set to discrete value such as 30 Kbps, 40 Kbps, 50 Kbps, 60 Kbps, 70 Kbps, 80 Kbps, 90 Kbps, and 100 Kbps. The description in this embodiment supposes that the optional play rates are the foregoing discrete values.

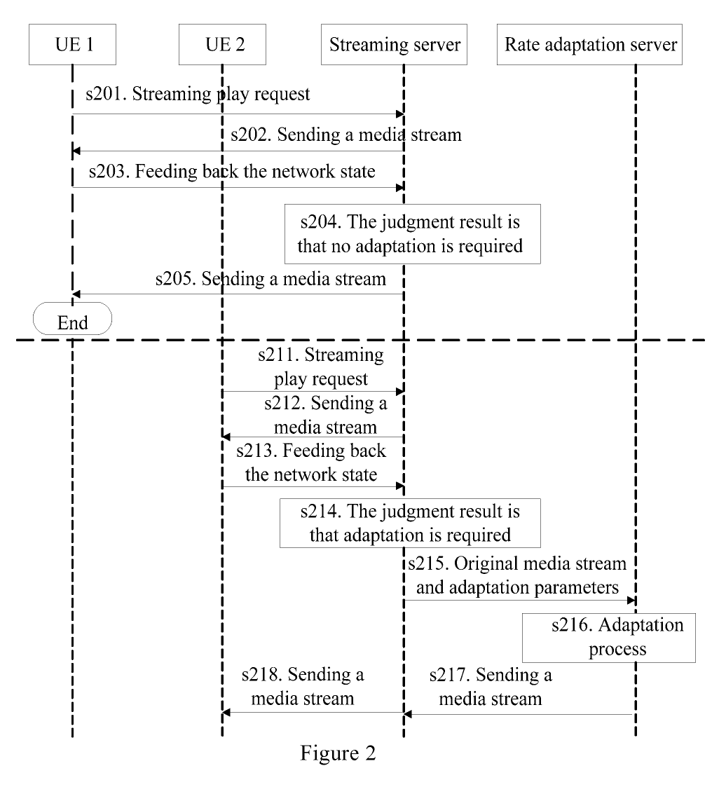

Supposing that the media stream of UE 1 needs no rate adaptation, as shown in FIG. 2, the process includes the following steps:

Step S201: UE 1 sends a streaming play request to the streaming server through the RTSP protocol.

Step S202: The streaming server sends a media stream to UE 1, and UE 1 plays the media stream. The rate of the media stream is 100 Kbps.

Step S203: UE 1 feeds back the current network state to the streaming server through the RTCP protocol in real time.

Step S204: The streaming server resolves the RTCP packet sent by UE 1, estimates the state of the network that contains UE 1 according to the parameters carried in the packet, and determines it unnecessary to adapt the rate of the media stream.

The RTCP packet carries the parameters such as maximum sequence number of the received packets, quantity of lost packets, delay jitters, and timestamp. According to such parameters, the streaming server may estimate the delay; according to the quantity of lost packets and the delay jitters, the streaming server judges whether the current rate of the media stream sent to UE 1 is appropriate. The judgment result here is supposed to be that no adaptation is required.

Step S205: The streaming server continues sending a further media stream to UE 1, and UE 1 plays the media stream and the process is ended.

Supposing that the media stream of UE 2 needs rate adaptation, as shown in FIG. 2, the process includes the following steps:

Step S211: UE 2 sends a streaming play request to the streaming server through the RTSP protocol.

Step S212: The streaming server sends a media stream to UE 2, and UE 2 plays the media stream. The rate of the media stream is 100 Kbps.

Step S213: UE 2 feeds back the current network state to the streaming server through the RTCP protocol in real time.

Step S214: The streaming server resolves the RTCP packet sent by UE 2, and estimates the state of the network that contains UE 2 according to the parameters carried in the packet, and determines it necessary to adapt the rate of the media stream.

The RTCP packet carries the parameters such as maximum sequence number of the received packets, quantity of lost packets, delay jitters, and timestamp. According to such parameters, the streaming server may estimate the delay; according to the quantity of lost packets and the delay jitters, the streaming server learns how to adjust the rate of sending the media stream so that the UE obtains better effect of playing the streaming file. In this step, supposing the streaming server according to the parameters carried in the packet estimates that the rate that matches the state of the radio network containing UE 2 is appropriately 82 Kbps.

Step S215: The streaming server sends the original media stream and the relevant required adaptation bandwidth parameters to the rate adaptation server.

In the sending process, the IP address of the destination rate adaptation server is 192.168.1.10, the sent content and the parameters include: original media stream represented in the RTP packet format, adaptation rate 82 Kbps, streaming server IP address 192.168.1.2, and connection ID (supposed to be 101) of the session that involves the current media stream.

Step S216: The rate adaptation server adapts the rate for the media stream.

After receiving the parameters sent by the streaming server whose IP address is 192.168.1.2, the rate adaptation server buffers the original media stream sent by the streaming server, and adapts the rate of each frame once the complete data of the frame is received. When selecting the target rate which is adapted, considering that the matching rate sent by the streaming server is 82 Kbps, in order to avoid frequent rate conversion, the rate adaptation server obtains the rate which is less than 82 Kbps and closest to 82 Kbps in the settings as a target rate, for example, 80 Kbps. Therefore, the rate is 80 Kbps after the original media stream of a 100 Kbps rate is adapted.

Step S217: The rate adaptation server sends the adapted media stream to the streaming server.

Once a frame is converted, the rate adaptation server sends the frame to the streaming server whose IP address is 192.168.1.2, and the frame carries the connection ID of the session that involves the adapted media stream. This ID is the same as the connection ID of the session that involves the media stream before adaptation, for example, 101.

Step S218: The streaming server sends the adapted media stream to UE 2.

According to the connection ID of the session that involves the media stream, the streaming server sends to UE 2 the adapted media stream whose rate is 80 Kbps, and UE 2 plays the new media stream.

After step S 218, the streaming server still judges whether it is necessary to adjust the rate of the media stream sent to UE 2 in real time based on the feedback of UE 2 according to the foregoing process. At a subsequent time t1, if the streaming server estimates that the rate supported by UE 2 is appropriately 85 Kbps, the streaming server sends the original media stream and the matching rate 85 Kbps to the rate adaptation server, and the rate adaptation server still adapts the rate of the original media stream to 80 Kbps according to the process described in step S 216. At a subsequent time t2, if the streaming server estimates that the rate supported by UE 2 is appropriately 75 Kbps, the rate adaptation server adapts the rate of the original media stream to 70 Kbps. At a subsequent time t3, if the streaming server estimates that the rate supported by UE 2 is appropriately 100 Kbps, the streaming server sends the original media stream to the UE directly, without adaptation at the rate adaptation server. The streaming rate control process at t1, t2 and t3 above is similar to the process described in steps S 211-S 218, and is not repeated here any further.

Through the streaming rate control method in the specific scenario described in the above embodiment, the streaming server collaborates with the rate adaptation server to control the streaming rate. The streaming server judges whether it is necessary to adapt the rate of the streaming media sent to the UE according to the feedback of the UE, and, if necessary, the streaming server sends to the UE the media stream adapted by the rate adaptation server. Therefore, the streaming source of only one rate needs to be stored on the streaming server, thus saving the storage space on the streaming server. Moreover, with an additional rate adaptation server, the streaming rates available to the network side are more diversified, and can meet the requirements of playing the streaming files in different network conditions.

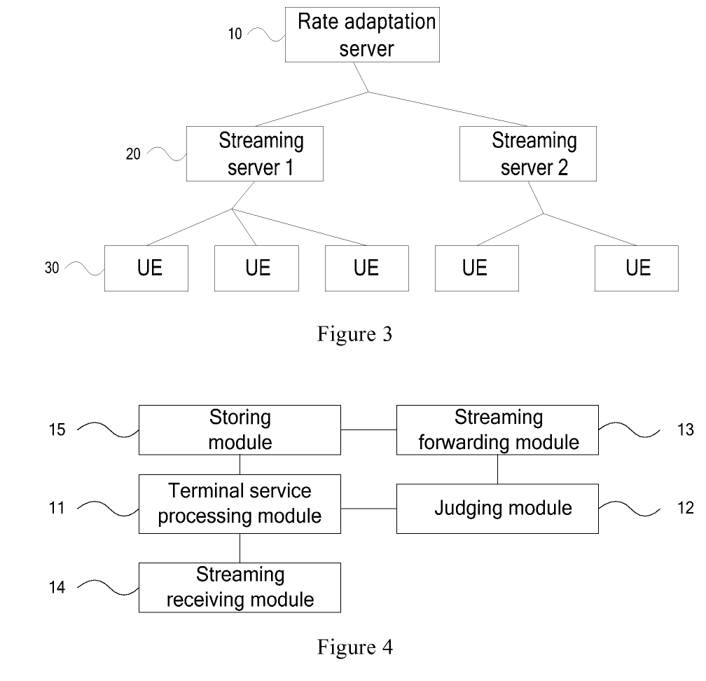

In one embodiment of the present disclosure, a streaming rate control system may include a UE, a streaming server and a rate adaptation server. As shown in FIG. 3, the system includes a rate adaptation server 10, a streaming server 20, and multiple UEs 30. The streaming server 1 provides streaming services for the three UEs connected to it, and the streaming server 2 provides streaming services for the two UEs connected to it. The rate adaptation server provides the rate adaptation service for both streaming server 1 and streaming server 2.

Specifically, the UE 30 receives the media stream sent by the streaming server 20, and feeds back the current network state to the streaming server 20 in real time.

The streaming server 20 judges whether it is necessary to adjust the rate of media stream sent to the UE 30 according to the network state fed back by the UE 30. If necessary, the streaming server 20 sends an original media stream and the rate that matches the network state of the UE to the rate adaptation server 10, and sends the media stream, which is adapted by and sent from the rate adaptation server 10, to the UE 30 corresponding to the media stream.

The rate adaptation server 10 adapts the rate of the original media stream from the streaming server 20 to the target rate according to the adaptation requirement of the streaming server 20, and sends the media stream to the streaming server 20.

In one of the present disclosure, as shown in FIG. 4, a streaming server may further include a terminal service processing module 11, a judging module 12, a streaming forwarding module 13, a streaming receiving 14, and a storing module 15.

The terminal service processing module 11 performs parallel sending and buffering control for streaming media and simple RTCP protocol resolution and control mechanism, and provides basic functions of streaming services. After receiving a media stream play request from the UE, the terminal service processing module 11 sends an original media stream to the UE, or sends to the UE the adapted media stream received from the streaming receiving module 14. Moreover, the terminal service processing module 11 receives the network state sent by the UE in real time, and forwards it to the judging module 12.

The judging module 12 judges whether it is necessary to adapt the rate of the media stream currently sent to the UE according to the network state fed back by the UE and received by the terminal service processing module 11, and, if necessary, sends the judgment result of requiring rate adaptation for the media stream to the streaming forwarding module 13.

The streaming forwarding module 13 sends the original media stream which needs to be adapted to the rate adaptation server in the network after receiving the message from the judging module 12, where the media stream carries the adaptation bandwidth parameters, for example, connection ID of the session that involves the media stream, and converted matching rate.

The streaming receiving module 14 receives the adapted media stream which is sent by the rate adaptation server in the network, and sends the adapted media stream and the corresponding session connection ID to the terminal service processing module 11.

The storing module 15 stores the original media stream file, and provides the original media stream when the terminal service processing module 11 needs to send the original media stream to the UE, or when the streaming forwarding module 13 needs to send the original media stream to the rate adaptation server in the network.

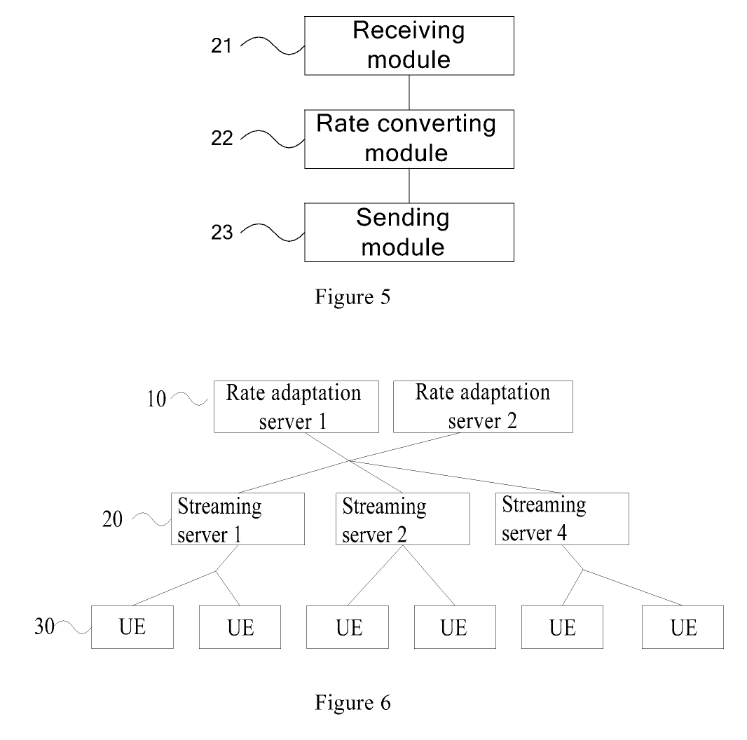

In one embodiment of the present disclosure, as shown in FIG. 5, a rate adaptation server may further include: a receiving module 21, a rate converting module 22, and a sending module 23.

The receiving module 21 receives the original media stream from the streaming server in the network and stores it into the buffer; and receives the adaptation bandwidth parameters from the streaming server, where the parameters may include the connection ID of the session that involves the media stream, and the converted matching rate.

The rate converting module 22 converts the rate of the original media stream according to the original media stream stored by the receiving module 21 in the buffer and the converted target rate, and sends the converted media stream to the sending module 23 in real time.

The sending module 23 sends the media stream converted by the rate converting module 22 to the corresponding streaming server in real time, where the media stream carries the connection ID of the session that involves the converted media stream.

In the above embodiments, the structure of the streaming rate control system is described, supposing that different streaming servers share a rate adaptation server. In practice, if the traffic is very high, one rate adaptation server is not enough, and the streaming rate adaptation service may be provided by a cluster of more rate adaptation servers. For example, as shown in FIG. 6, in the network in one embodiment of the present disclosure, two rate adaptation servers provide the streaming rate conversion service for three streaming servers, where the IP addresses of the two rate adaptation servers are 192.168.1.10 and 192.168.1.11 respectively and the IP addresses of the three streaming servers are 192.168.1.2, 192.168.1.3 and 192.168.1.2 respectively. When all three streaming servers send original media streams for adaptation to the rate adaptation server, if the traffic is very high and the processing speed of one rate adaptation server is not enough, the two rate adaptation servers may shunt the traffic to meet the service requirements of the three streaming servers. For example, when the traffic of the rate adaptation server whose IP address is 192.168.1.10 reaches the limit, this rate adaptation server diverts the newly received service requests to the rate adaptation server whose IP address is 192.168.1.11; or notifies the sender of the new service request to send the request to the rate adaptation server whose IP address is 192.168.1.11. During the processing, the streaming server and the rate adaptation server may identify the same device according to different IDs and contact with each other.

Through the streaming rate control system, streaming server and rate adaptation server described in the embodiments above, when the streaming server needs to adjust the streaming rate sent to the UE, the rate adaptation server adapts the media stream that needs rate adjustment, and the streaming server sends the adapted media stream to the UE. Therefore, the streaming source of only one rate needs to be stored on the streaming server, thus saving the storage space on the streaming server. Moreover, by adding a rate adaptation server, the streaming rates available to the network side are more diversified, and can meet the requirements of playing the streaming files in different network conditions.

Through the above embodiments, those skilled in the art understand that the invention may be realized through software and general hardware platforms or through hardware only. In most cases, it is preferred to use software and general hardware platforms. Based on such understandings, the technical solution under the present invention or contributions to the prior art can be embodied by software products. The software is stored in a storage medium and incorporates several instructions to instruct a computer device, for example, a PC, server, or network device, to execute the method provided in the embodiments of the present invention. Disclosed above are only several embodiments of the present invention. However, the present invention is not limited to such embodiments, and variations made by those skilled in the art shall fall into the protection scope of the present invention.

Although the invention has been described through some exemplary embodiments, the invention is not limited to such embodiments. It is apparent that those skilled in the art can make various modifications and variations to the invention without departing from the spirit and scope of the invention. The invention shall cover the modifications and variations provided that they fall in the scope of protection defined by the following claims or their equivalents.

What is claimed is:

1. A streaming rate control method, comprising:
judging whether a rate of a media stream sent to a User Equipment (UE) is appropriate according to network state fed back by the UE;
obtaining adaptation parameters when the rate is inappropriate;
adapting the rate of the media stream according to the adaptation parameters; and
sending the adapted media stream to the UE.

2. The streaming rate control method of claim 1, wherein the process of the determining whether a rate of a media stream sent to a User Equipment (UE) is appropriate according to network state fed back by the UE comprises:
receiving, by a streaming server, a current network state fed back by the UE, wherein the network state comprises at least one of maximum sequence number of packets received by the UE, quantity of lost packets, delay jitters, and timestamp; and
determining whether the rate of the media stream matches the network state, if the rate mismatches, the rate is inappropriate.

3. The streaming rate control method of claim 1, the method further comprising:
obtaining, by the streaming server, an address of a rate adaptation server; and
sending, by the streaming server, an original media stream and adaptation parameters to the rate adaptation server according to the address, wherein the adaptation parameters comprise an ID of a session that involves the original media stream and a matching rate that matches the network state.

4. The streaming rate control method of claim 2, wherein if target rates obtained after adaptation by the rate adaptation server are continuous rate values, the process of adapting the rate of the media stream according to the adaptation parameters comprises:
storing, by the rate adaptation server, the original media stream sent by the streaming server into a buffer;
adapting the rate of a multimedia frame to the matching rate once a complete multimedia frame is received; and
sending the adapted multimedia frame to the streaming server.

5. The streaming rate control method of claim 2, wherein: if target rates obtained after adaptation by the rate adaptation server are discrete rate values, the process of adapting the rate of the media stream according to the adaptation parameters comprises:
storing, by the rate adaptation server, the original media stream sent by the streaming server into a buffer;
once a complete multimedia frame is received, adapting the rate of the multimedia frame to a value that is less than and closest to the matching rate among the discrete rate values; and
sending the adapted multimedia frame to the streaming server.

6. The streaming rate control method of claim 2, wherein: the process of sending the adapted media stream to the UE comprises:
receiving, by the streaming server, the media stream that carries the adapted multimedia frame;
obtaining the ID of the session that involves the media stream; and
sending the adapted media stream to the UE corresponding to the ID.

7. A streaming rate control system, comprising:
a streaming server, adapted to send an original media stream and adaptation parameters to a rate adaptation server, and send to the UE an adapted media stream sent by the rate adaptation server, when determining it necessary to adjust a rate of a media stream sent to a User Equipment (UE) according to a network state fed back by the UE; and
a rate adaptation server, adapted to adapt the rate of the original media stream sent by the streaming server, and send the original media stream to the streaming server, according to the adaptation parameters sent by the streaming server.

8. The streaming rate control system of claim 7, wherein if target rate values obtained after adaptation by the rate adaptation server are continuous rate values, the rate adaptation server stores the original media stream sent by the streaming server into a buffer;
once a complete multimedia frame is stored, the rate adaptation server adapts the rate of the multimedia frame to a matching rate carried in the adaptation parameters, and sends the adapted multimedia frame to the streaming server.

9. The streaming rate control system of claim 7, wherein if target rate values obtained after adaptation by the rate adaptation server are discrete rate values, the rate adaptation server stores the original media stream sent by the streaming server into a buffer;
once a complete multimedia frame is stored, the rate adaptation server adapts the rate of the multimedia frame to a rate that is less than and closest to the matching rate carried in the adaptation parameters among the discrete rate values, and sends the adapted multimedia frame to the streaming server.

10. A streaming server, comprising:
a judging module, adapted to judge whether it is necessary to adapt a rate of a media stream sent to a User Equipment (UE) according to a network state fed back by the UE, and send a judgment result of requiring rate adaptation to a streaming forwarding module;
a streaming forwarding module, adapted to send an original media stream to be adapted and adaptation parameters to a rate adaptation server in a network; and
a streaming receiving module, adapted to receive an adapted media stream sent by the rate adaptation server in the network.

11. The streaming server of claim 10, further comprising:
a terminal service processing module, adapted to send the media stream to the UE, and send the network state fed back by the UE to the judging module; and
a storing module, adapted to store an original streaming file and provide the file for the terminal service processing module and the streaming forwarding module.

12. A rate adaptation server, comprising:
a receiving module, adapted to store an original media stream sent by a streaming server into a buffer, and provide the media stream for a rate converting module;
a rate converting module, adapted to perform rate adaptation for the media stream received by the receiving module according to adaptation parameters sent by the streaming server; and
a sending module, adapted to send the media stream adapted by the rate converting module to the streaming server.

13. The rate adaptation server of claim 12, wherein if target rates obtained after adaptation by the rate adaptation server are continuous rate values, the rate converting module adapts a rate of the original media stream, which is stored by the receiving module into the buffer, to a matching rate carried in the adaptation parameters.

14. The rate adaptation server of claim 12, wherein if target rates obtained after adaptation by the rate adaptation server are discrete rate values, the rate converting module adapts the rate of the original media stream, which is stored by the receiving module into the buffer, to a rate that is less than and closest to the matching rate carried in the adaptation parameters among the discrete rate values.
